(19) United States
(12) Patent Application Publication
(10) Pub. No.: US 2019/0226168 A1
(43) Pub. Date: Jul. 25, 2019

(54) PARKING LOT SWEEPER HEAD WHEEL GUIDE

(71) Applicant: Brian Slane, Cassville, MO (US)

(72) Inventor: Brian Slane, Cassville, MO (US)

(21) Appl. No.: 15/875,348

(22) Filed: Jan. 19, 2018

(51) Int. Cl. E01H 1/08; E01H 1/05; A01G 20/47; E01H 1/04

(52) U.S. Cl. CPC E01H 1/08; E01H 1/05; B60G 9/025; E01H 1/04; A01G 20/47

(57) ABSTRACT

A road or parking lot sweeper head comprises a sweeper base chassis comprised of a wheel carriage having at least two wheels attached. The wheel carriage attaches to an outer side of the sweeper base chassis and comprises a first wheel on a first side of the sweeper base chassis and a second wheel on a second side of the sweeper base chassis. Wherein the first wheel and the second wheel position the sweeper head above a surface at a proper operating height for an associated vacuum and to engage the surface in operation and prevent any portion of the sweeper head from contacting and damaging said surface.

### CROSS-REFERENCE TO RELATED APPLICATION(S)

Not applicable

### BACKGROUND OF THE INVENTION

### 1. Field of Invention

The present invention relates to the parking lot sweepers, more particularly to a sweeper truck sweeper head contacting a parking lot surface.

### 2. Description of Related Art

Sweeper trucks utilize a sweeper head with drag shoe skids that rests against the parking lot surface for a vacuuming mechanism to vacuum debris into the truck. FIG. 1 shows an example of a prior art sweeper truck 100 equipped with a prior art sweeper head 105 behind a rotary sweeper 110, which vacuums up debris swept inward for vacuuming by the sweeper head 105. A drag shoe skid 115 positioned on the side of the sweeper head 105 keeps the sweeper head 105 vertically spaced above a road or parking lot surface to properly vacuum up debris.

The drag shoe skid 115 contacting and damaging the parking lot occurs frequently. When this happens, the drag shoe skid 115 causes visible scrapes and other damage to asphalt or concrete road or parking lot surfaces. This further can cause wear and/or damage to the drag shoe skid 115, sweeper skirt, and/or the sweeper head 105 itself, increasing labor and parts costs and reducing the usable life of the sweeper skirt.

Based on the foregoing, there is a need in the art a system, which will facilitate keeping a sweeper head vertically positioned while avoiding contact with a road or parking lot surface.

### SUMMARY OF THE INVENTION

A road or parking lot sweeper head comprising a sweeper wheel carriage having at least four wheels attached. The four wheels comprises a first and second wheel attached to a first side of the sweeper base chassis and a third and fourth wheel attached to a second side of the sweeper base chassis. The four wheels position the sweeper head above a surface at a proper operating height for an associated vacuum and to engage the surface in operation and prevent any portion of the sweeper head from contacting and damaging said surface.

The wheels comprise swivel wheels positioned under a truck body and further comprise longitudinal adjustable arms with a mounting bracket at the ends for receiving said swivel wheels, wherein the longitudinal arms adjustably attach to the wheel carriage.

The wheel carriage attaches to the sweeper base chassis with a fixed attachment.

The wheel carriage attaches to the sweeper base chassis with an adjustable attachment.

The adjustable attachment comprises a vertical slot and a nut and bolt.

The first side of the sweeper head the first wheel attaches to a first end of the wheel carriage and the second wheel attaches to a second end of the wheel carriage, and the first and second wheel longitudinally positioned by the wheel carriage opposite each other and positioned on the first side of the sweeper base chassis respectfully. The second side of the sweeper head with the third wheel attaching to a first end of the wheel carriage and the fourth wheel attaching to a second end of the wheel carriage, and the third and fourth wheel longitudinally positioned by the wheel carriage opposite each other and positioned on the second side of the sweeper base chassis respectfully. The first and second wheel are laterally positioned opposite of the third and fourth wheel.

The sweeper head attaches to a truck using an attachment comprising a spring tension adjustment assembly comprised of a turnbuckle and a spring.

A road or parking lot sweeper head comprising a sweeper base chassis comprised of a first wheel carriage having at least two wheels attached. The first wheel carriage attaches to an outer side of the sweeper base chassis and comprises a first wheel on a first end of the sweeper base chassis and a second wheel on a second end of the sweeper base chassis. The first wheel and the second wheel position the sweeper head above a surface at a proper operating height for an associated vacuum and to engage the surface in operation and prevent any portion of the sweeper base chassis from contacting and damaging said surface.

The first wheel attaches to a first end of the first wheel carriage and the second wheel attaches to a second end of the first wheel carriage, the first and second wheel longitudinally positioned by the wheel carriage opposite each other and positioned on the outer side of the sweeper base chassis respectfully. Further comprises a second wheel carriage on a second side opposite from the outer side, with a third wheel attaches to a first end of the second wheel carriage and a fourth wheel attaches to a second end of the second wheel carriage, the third and fourth wheel longitudinally positioned by the wheel carriage opposite each other and positioned on the second side of the sweeper base chassis respectfully.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a side view of a prior art sweeper;

FIG. 2A is a side view of the wheel guided sweeper head, according to an embodiment of the present invention;

FIG. 2B is an enlarged side view of the wheel guided sweeper head, according to an embodiment of the present invention;

FIG. 2C is another enlarged side view of the wheel guided sweeper head, according to an embodiment of the present invention;

FIG. 2D is a top view of the wheel guided sweeper head, according to an embodiment of the present invention;

FIG. 3 is a ¾ side view of the wheel guided sweeper head, according to an embodiment of the present invention;

FIG. 4 is an enlarged ¾ top view of the sweeper head showing an enlarged curb and bolt protector, according to an embodiment of the present invention;

FIG. 5 is a side view of a T-bar and spring tension adjustment assembly, according to an embodiment of the present invention;

FIG. 6 is an enlarged side view of the wheel castor assembly, according to an embodiment of the present invention; and

FIG. 7 is a side view of a sweeper truck with the wheeled guided sweeper head, according to an embodiment of the present invention.

### DETAILED DESCRIPTION OF PREFERRED EMBODIMENTS

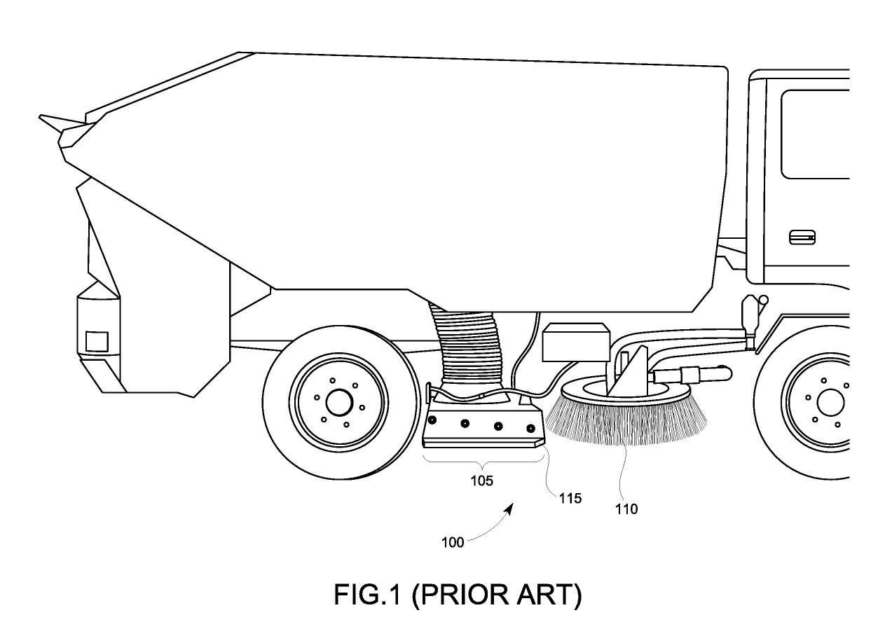

Preferred embodiments of the present invention and their advantages may be understood by referring to FIGS. 1-7, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

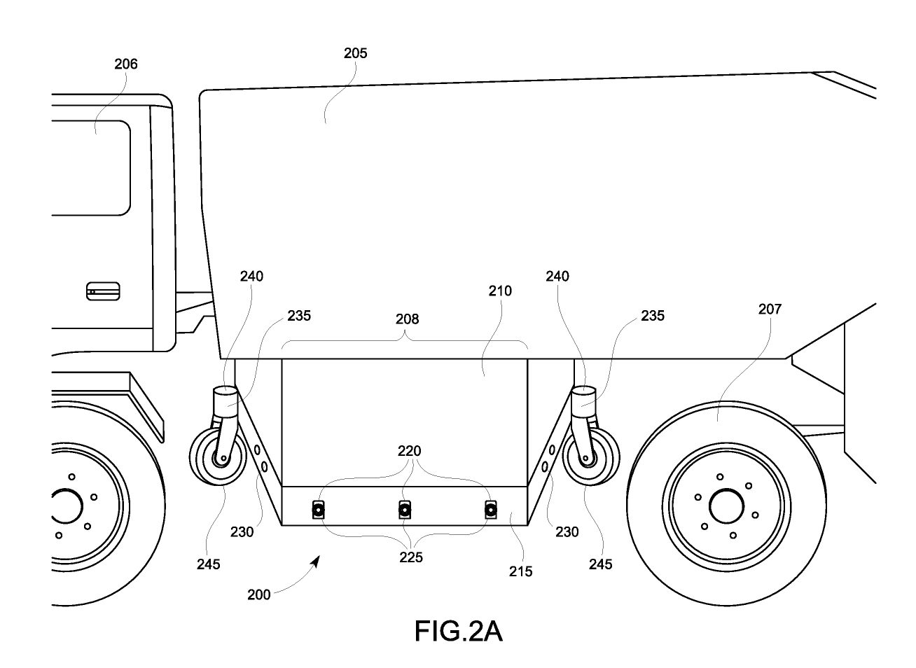

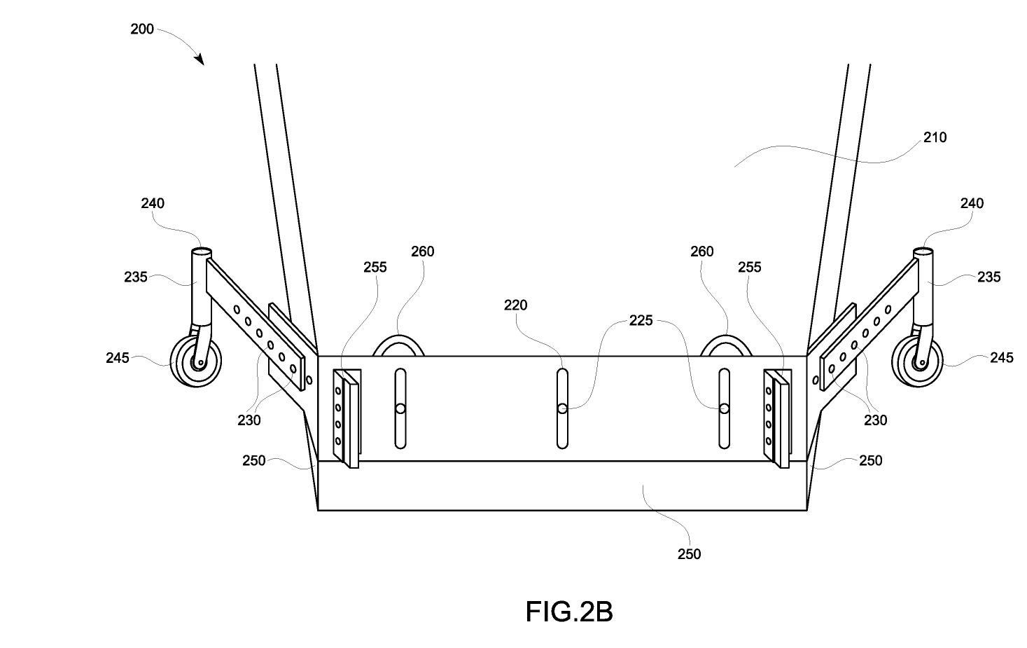

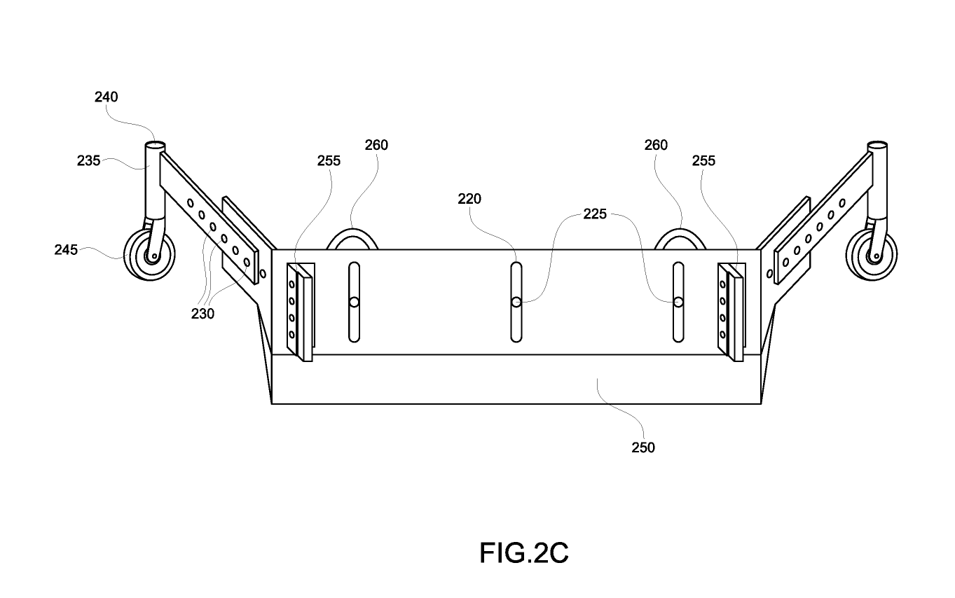

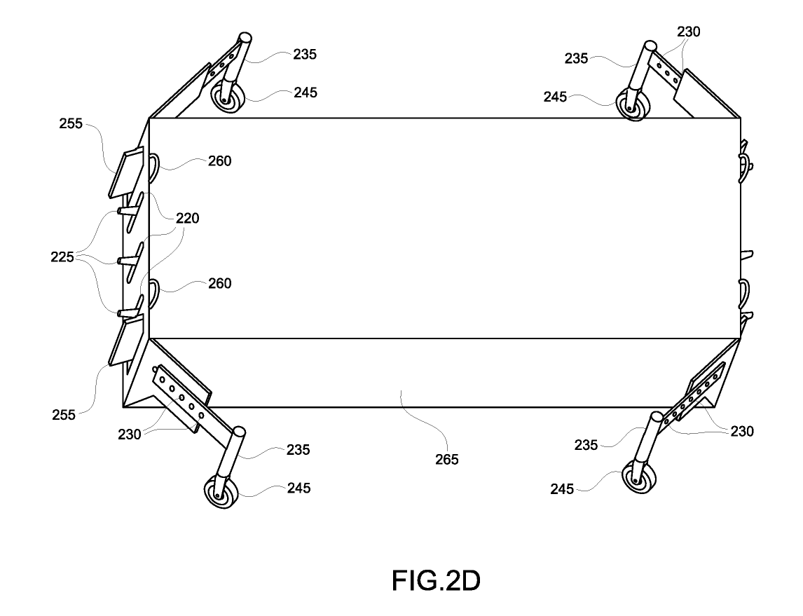

FIG. 2A shows a side view of a sweeper head assembly 200 fitted with an adjustable wheel carriage 215. As shown, a truck 205 includes a truck cab 206 and a rear wheel 207. A sweeper head 208 extends down from the truck 205 and can include a sweeper top skirt 210 covering other components of the sweeper head 208. A vertical slot 220 on the wheel carriage 215 can allow for vertical adjustment of wheel carriage 215 secured in place by nuts and bolts 225. Adjustable arms 230 can provide longitudinal positioning of swivel wheels 245 under the truck 205. The swivel wheels 245 on the wheel carriage 215 roll over a surface and prevent contact with the surface. The adjustably attached wheel carriage 215 on the base and outer side of the sweeper head 208 allows vertical positioning of the sweeper head 208 over a surface for proper operation of the truck's vacuum and prevent impacts with a surface. The adjustable arms 230 terminate in swivel bracket 235 and can include a ball bearing mounting 240 supporting swivel wheels 245, and further allow the swivel wheels 245 to be optimally positioned under the truck.

FIG. 2B and FIG. 2C are enlarged views of FIG. 2A, and the elements depicted are identical with the same identifiers. FIG. 2B includes the sweeper head assembly 200 with sweeper skirt 210 covering components. A vertical slot 220 on the wheel carriage 215 can allow for vertical adjustment of wheel carriage 215 secured in place by nuts and bolts 225. Adjustable arms 230 can provide longitudinal positioning of swivel wheels 245. The swivel wheels 245 on the wheel carriage 215 roll over a surface and prevent contact with the surface. The adjustably attached wheel carriage 215 on the base and outer side of the sweeper head 200 allows vertical positioning of the sweeper head 200 over a surface for proper operation of the truck's vacuum and prevent impacts with a surface. The adjustable arms 230 terminate in swivel bracket 235 and can include a ball bearing mounting 240 supporting swivel wheels 245, and further allow the swivel wheels 245 to be optimally positioned under the truck. Side skirt 250 can extend down to the surface to ensure maintaining vacuum pressure under sweeper head assembly 200. Curb and bolt protectors 255 attach to the side of the sweeper head assembly 200 to protect both road curbs and the nuts and bolts 225 from impacts. Spring hooks 260 can be used to suspend the sweeper head assembly 200.

FIG. 2C shows an enlarged side view of the front part of FIG. 2B. As depicted, the curb and bolt protectors 255 can be mounted at an angle to reduce the chances of binding on a curbside.

FIG. 2D shows a top view of the sweeper head assembly 200. As shown, the sweeper head assembly can include four swivel wheels 245 with angled adjustable arms 230. Back skirt 265 extends down toward the road/lot surface to help maintain vacuum pressure. The vertical slots 220 allow vertical adjustment of the sweeper head assembly 200 secured by nuts and bolts 225 to set any vertical adjustments.

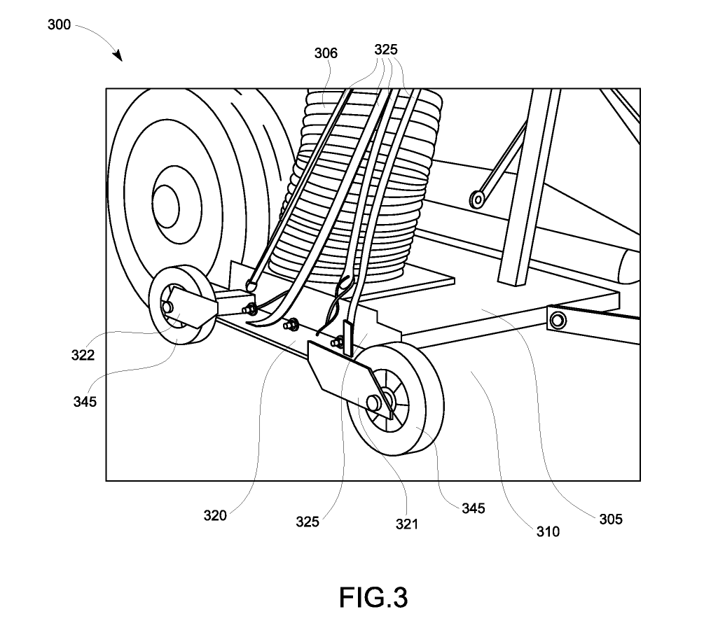

FIG. 3 depicts a ¾ side view of a wheel guided sweeper head 300 according to an embodiment. Sweeper head 300 can comprise a sweeper base chassis 305 that can attach to the underside of a truck and provide an attachment for a vacuum hose 306. Sweeper skirt 310 hangs down from sweeper base chassis 305 to aid in forming a vacuum. A wheel carriage 320 can attach to an outer side of the sweeper base chassis 305 in either a fixed or adjustable configuration. Wheel carriage 320 can comprise two ends; a front end 321 and a rear end 322. The sweeper base chassis 305 and wheel carriage 320 can attach to the truck using elastic straps 325. Wheel carriage 320 essentially replaces the drag shoe skid 115 on the side of the sweeper 300. Rubber rimmed wheels 345 can be positioned at both ends of the wheel cradle 320 to provide proper vertical clearance for operation of the vacuum of the truck and prevent impact of the sweeper head 300 with the road or parking lot surface causing damage.

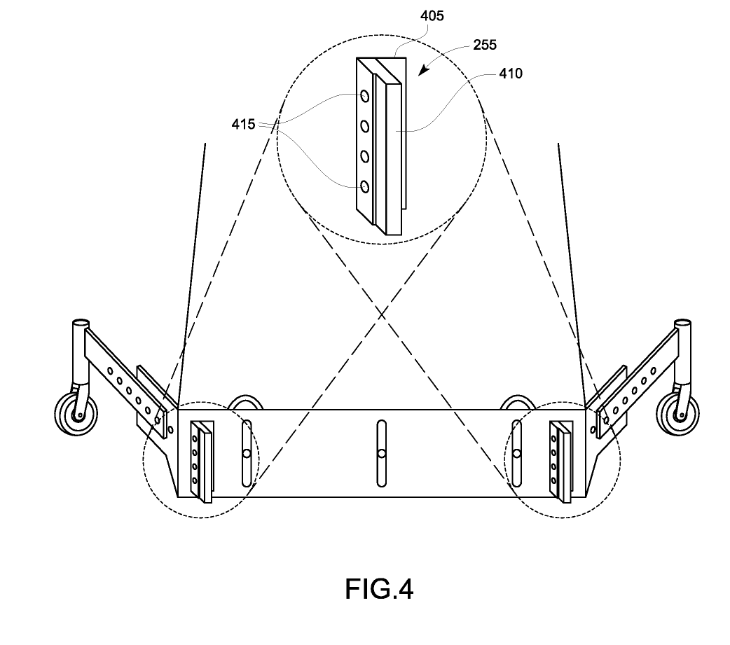

FIG. 4 shows an enlarged view with additional details on curb and bolt protector. Curb and bolt protector 255 comprises an angled metal bracket 405 that bolts to the side of sweeper head assembly 200. The curb and bolt protector 255 can be welded to the sweeper head 208. Thick belt material 410 can protrude from the angle metal 405, and this thick belt material can be replaced by removing bolts 415 and replacing as required.

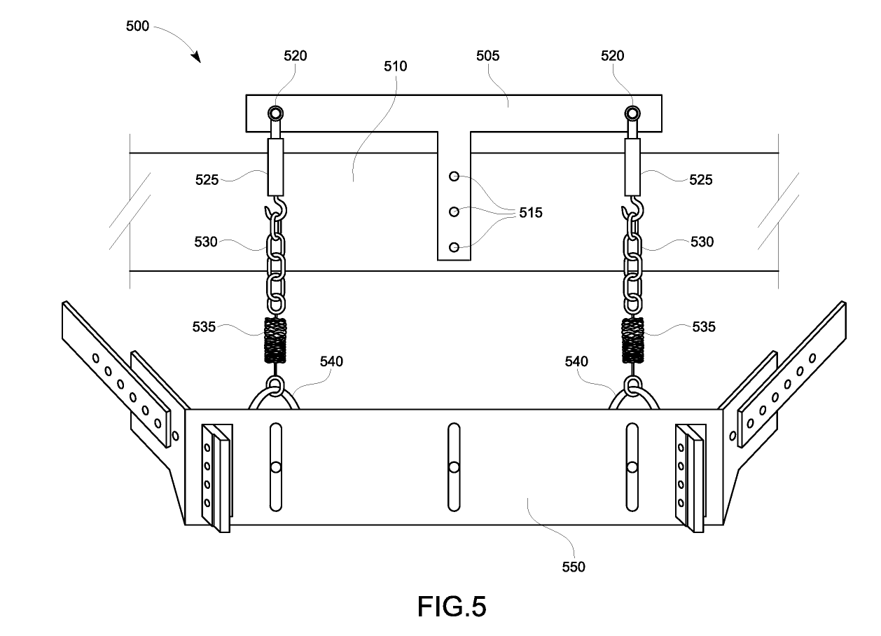

FIG. 5 depicts a side view of a T-bar and spring tension adjustment assembly to attach sweeper head 200 to a truck. T-bar 505 is secured to a truck/vehicle frame 510 by bolts 515. The top of the T-bar 505 is left free to minimize shock and vibration forces transferred to the vehicle by the spring tension and adjustment assembly, which is attached by bolts 520 to the T-bar 505. The spring tension and adjustment assembly includes a tension adjustment turnbuckle 525 bolted to the T-bar 505 connecting to chain 530 interposed between tension adjustment turnbuckles 525 and springs

535. Spring 535 connects to spring hooks 540 connected to wheel carriage 550 of the sweeper head assembly 200. The chain (i.e., turnbuckle 525, chain 530, and spring 535) can be adjusted in length to compensate for different heights of trucks. While sweeper head 200 is down in its operating position, the chain can be adjusted to optimal tension to allow the sweeper assembly 200 to compensate the surface to retain pre-gauged skirt height or distance from the surface.

The T-bar and spring tension adjustment assembly 500 is required to lighten the load on the sweeper head 200 and prolong the life of the wheels 245.

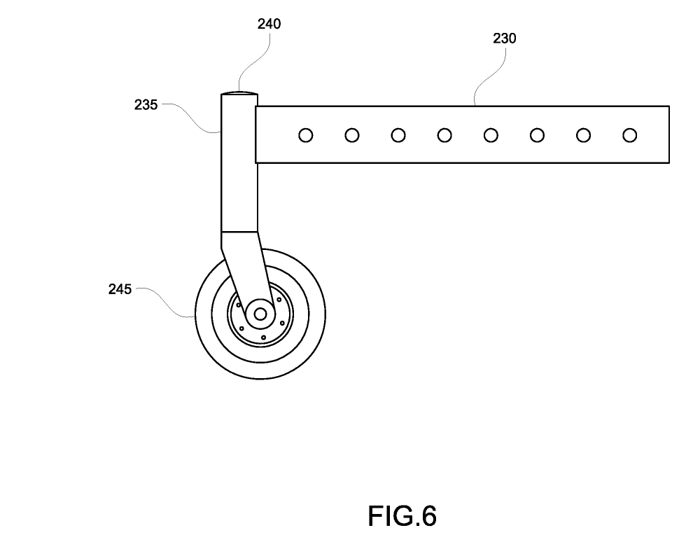

FIG. 6 depicts an enlarged view of the wheel castor and adjustment assembly. Adjustable arms 230 can provide longitudinal positioning of swivel wheels 245. The adjustable arms 230 can terminate in swivel bracket 235 and can include a ball bearing mounting 240 supporting swivel wheels 245. The wheel castor and adjustment assembly further allows the swivel wheels 245 to be optimally positioned under the truck.

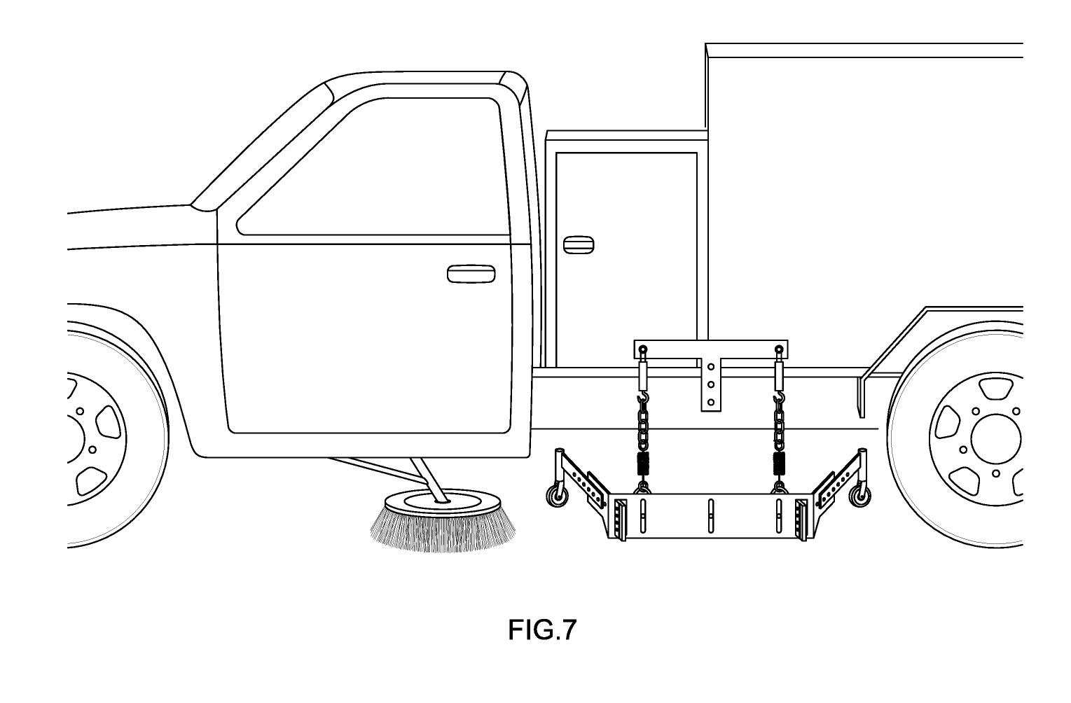

FIG. 7 shows a side view of a truck with the sweeper head assembly installed.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A road or parking lot sweeper head, comprising:
a sweeper wheel carriage having at least four wheels attached;
wherein the four wheels comprises a first and second wheel attached to a first side of the sweeper base chassis and a third and fourth wheel attached to a second side of the sweeper base chassis;
wherein the four wheels position the sweeper head above a surface at a proper operating height for an associated vacuum and to engage the surface in operation and prevent any portion of the sweeper head from contacting and damaging said surface.

2. The road or parking lot sweeper head of claim 1, wherein the wheels comprise swivel wheels positioned under a truck body and further comprise longitudinal adjustable arms with a mounting bracket at the ends for receiving said swivel wheels, wherein the longitudinal arms adjustably attach to the wheel carriage.

3. The road or parking lot sweeper head of claim 1, wherein the wheel carriage attaches to the sweeper base chassis with a fixed attachment.

4. The road or parking lot sweeper head of claim 1, wherein the wheel carriage attaches to the sweeper base chassis with an adjustable attachment.

5. The road or parking lot sweeper head of claim 4, wherein the adjustable attachment comprises a vertical slot and a nut and bolt.

6. The road or parking lot sweeper head of claim 1,
wherein on the first side of the sweeper head the first wheel attaches to a first end of the wheel carriage and the second wheel attaches to a second end of the wheel carriage, the first and second wheel longitudinally positioned by the wheel carriage opposite each other and positioned on the first side of the sweeper base chassis respectfully; and
wherein on the second side of the sweeper head the third wheel attaches to the first end of the wheel carriage and the fourth wheel attaches to the second end of the wheel carriage, the third and fourth wheel longitudinally positioned by the wheel carriage opposite each other and positioned on the second side of the sweeper base chassis respectfully; and
wherein the first and second wheel are laterally positioned opposite of the third and fourth wheel.

7. The road or parking lot sweeper head of claim 1, wherein the sweeper head attaches to a truck using an attachment comprising a spring tension adjustment assembly comprising a turnbuckle and a spring.

8. A road or parking lot sweeper head, comprising:
a sweeper base chassis comprised of a first wheel carriage having at least two wheels attached;
wherein the first wheel carriage attaches to an outer side of the sweeper base chassis and comprises a first wheel on a first end of the sweeper base chassis and a second wheel on a second end of the sweeper base chassis;
wherein the first wheel and the second wheel position the sweeper head above a surface at a proper operating height for an associated vacuum and to engage the surface in operation and prevent any portion of the sweeper base chassis from contacting and damaging said surface.

9. The road or parking lot sweeper head of claim 8,
wherein the first wheel attaches to a first end of the first wheel carriage and the second wheel attaches to a second end of the first wheel carriage, the first and second wheel longitudinally positioned by the wheel carriage opposite each other and positioned on the outer side of the sweeper base chassis respectfully; and
further comprises a second wheel carriage on a second side opposite from the outer side, with a third wheel attaching to a first end of the second wheel carriage and a fourth wheel attaching to a second end of the second wheel carriage, the third and fourth wheel longitudinally positioned by the wheel carriage opposite each other and positioned on the second side of the sweeper base chassis respectfully.
